(19) United States
(12) Patent Application Publication
(10) Pub. No.: US 2006/0011546 A1
(43) Pub. Date: Jan. 19, 2006

(54) Portable compact ultra high purity water system via direct processing from city feed water

(76) Inventor: Robert C Livingston, Hyannis, MA (US)

Correspondence Address: GREENBERG TRAURIG, LLP, MET LIFE BUILDING, 200 PARK AVENUE, NEW YORK, NY, 10166, US

(21) Appl. No.: 10/521,845

(22) PCT Filed: Jul. 14, 2003
(86) PCT No.: PCT/US03/21734

§ 371 Date: Jul. 1, 2005

Related U.S. Application Data
(60) Provisional application No. 60/319,407, filed on Jul. 19, 2002.

(51) Int. Cl. B01D 61/00

(52) U.S. Cl. 210/652

(57) ABSTRACT

The present invention relates to a water purification system. This system is portable, compact and produces ultra higher purity water. The system is suitable for use with direct processing from city feed water.

This application claims priority from U.S. Provisional Application No. 60/396,315 filed Jul. 17, 2002.

### BACKGROUND

This invention relates to a portable compact ultra high purity water system, which is suitable for use with direct processing from city feed water.

The high purity water industry began shortly after the widespread use of steam power utilized for manufacturing purposes during the industrial revolution. Softened water was soon identified as an urgent need by the not uncommon but devastatingly powerful explosion of steam boilers due to hardness scale. Filtration was added and together with softening provided the pretreatment for distillation. Initially, distillation was the most reliable form of high purity water processing and remains a staple in the pharmaceutical industry to this day.

Modern ultra high purity water production began as a by-product of the Nuclear Age. The harnessing of nuclear energy demanded ultra high purity water be available in large quantities and of exceptional purity to prevent the radioactive contamination of any contaminants of the water used in emerging nuclear technologies. Modern ion exchange and the production of ultra pure 18 MegOhm water was invented and perfected by Dr. Robert Kunin during the brief lifetime of the Manhattan Project. Reverse osmosis, a purification technique based on membrane technology, became commercially viable in the 1970's, and has become a central technology in high purity water processing.

Today, state of the art industrial high purity water systems utilize some or all of the following technologies to provide water that is approaching the theoretical ideal for pure water.
Pretreatment
   Sand
   Carbon
   Softener
Purification
   Reverse Osmosis (RO) or Double Pass RO
   CDI or EDI (Electrical Deionization)
   Regenerable Mixed Bed Deionization
Post Treatment
   Ultra-Violet TOC reduction Technology
   Polishing Mixed Bed Deionization
   Final filtration or Ultra filtration (UF)

High purity water is utilized in numerous applications in some way by virtually all technical research and manufacturing endeavors. A major component of modern semiconductor and biopharmaceutical manufacturing is a continuously available supply of exceedingly high purity water. Other major applications include the medical instruments, cosmetics, toiletries, photonics, aerospace, pharmaceutical, electronics manufacturing and power generation. Ultra high purity water cannot be bottled or stored, but must be manufactured as required, else it immediately degenerates into a lesser quality due to the “universal solvent” nature of deionized water. In order to manufacture water as required, users must utilize a high purity water system on site to provide ultra high purity on demand. The system range from small stills, through to wall mounted water systems to industrial manufacturing water systems housed in their own buildings to vast desalinization plants occupying acres providing drinking water from sea water for entire islands.

The high purity water is used by various Industries for technical cleaning, degreasing, research, and as a stable and refined constituent of reagents, solutions and products.

Ample supplies of high purity water have become a required utility for modern technical manufacturing. One problem, however, with present day high purity water systems is that they employ one or more storage tanks to store intermediary water. The use of these storage tanks results in large, bulky water purification systems which are neither compact nor portable.

### THIS INVENTION

It is the purpose of this invention to provide uninterrupted supplies of significant quantities of exceedingly high quality water for demanding technical applications from diverse feed water sources from a portable and compact water system design.

This water system is unique in that that:
The system employs state of the art technology in conjunction with a unique water processing technique eliminating the customary storage of intermediary quality water allowing for a compact and portable design.
It reliably provides exceptionally high quality, low microbiology product water exceeding the requirements for the following industry specifications:
   USP Purified and WFI Water
   Reagent grade Type 1 water
   NACCLS Type 1
The high quality, high output system provides larger quantities of product water than can be supplied from wall mounted systems, yet does not require a fixed installation of a typical system of this capacity. The system is self contained, compact and portable.
The system may be operated from any potable feed water supply.
The robust system design allows for extended use at high output capacity without the need for frequent or unscheduled maintenance or replenishment.

This invention provides users with significant quantities (2 gpm minimum) of exceedingly high quality water (See attached specification), on demand, from any potable water source, via a compact and portable design that does not require a fixed installation.

The portability is the result of a novel design that does not utilize a storage tank to accumulate intermediate grade water for high purity processing on demand.

### DESCRIPTION OF DRAWINGS

FIG. 1 is a side view of one embodiment of the claimed invention.

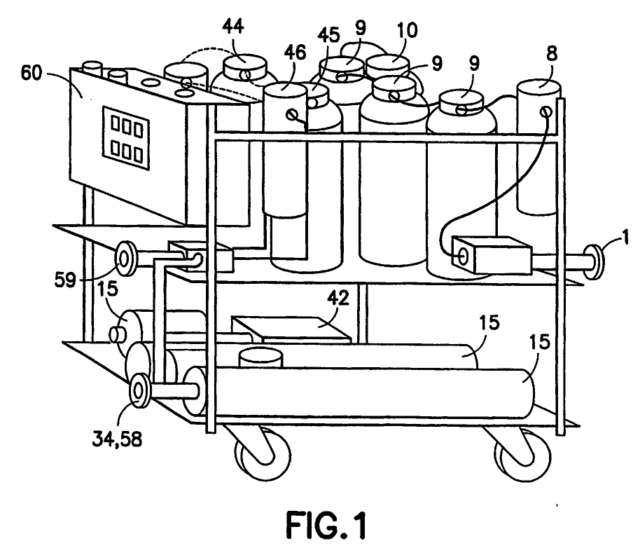

FIG. 2 is a schematic showing one embodiment of the present invention from beginning though the Reverse Osmosis (RO) system.

FIG. 2b is a schematic showing one embodiment of the present invention from after the Reverse Osmosis (RO) system through completion.

FIG. 3a through FIG. 3e are, respectively, a left side view, a back view, a front view, a right side view and a top view of one embodiment of the claimed invention.

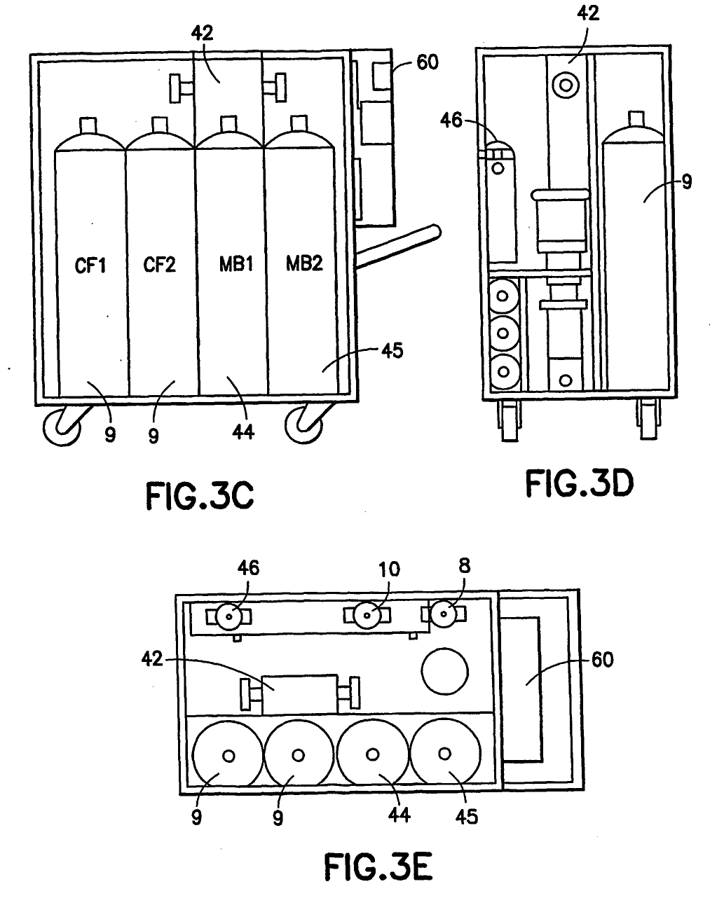

FIG. 4a through 4c are, respectively, a front view, a side view and an interior view of the control panel in one embodiment of the claimed invention.

### GENERAL SYSTEM DESCRIPTION

The following brief is a description of each process that the water passes through as it is purified by the inventive water system. The system described uses city water, although this invention has applications to other sources of water as well.

Backflow Preventer:

Water passes through a reduced pressure backflow preventer which isolates city water from the process water which will be purified by this system, as required by local plumbing codes.

Prefilter:

City feed water is passed through a cartridge filter, preferably a 5 micron nominally rated cartridge filter in order to remove fine particles prior to the carbon filter. Inlet and outlet pressure gauges are supplied to monitor the pressure drop across this filter, which should be changed out when the pressure drop is 10-15 psig over and above the clean pressure drop for most effective operation and efficiency. The filter elements are made of a material which is unable to support the growth of bacteria, preferably polyurethane.

Carbon Filter:

Filtered water is passed through a carbon filter for the effective removal of light molecular weight organics and chlorine found in the incoming water supply. The granular carbon media should be preferably changed every 3 months or every 50,000 gallons, based on chlorine and or organic breakthrough, or excess bacteria counts. Inlet and outlet pressure gauges are supplied to monitor the pressure drop across this filter. Inlet and outlet sample valves are furnished for sampling purposes.

Carbon Filter: Optional Spare Vessel

Filtered water is passed again through a carbon filter for the effective removal of chloramines and light molecular weight organics and chlorine found in the incoming water supply. The second pass through carbon allows for the complete disassociation of the chloramines and the removal of the resultant chlorine. The granular carbon media should preferably be changed every 3 months or every 50,000 gallons, based on chlorine and or organic breakthrough, or excess bacteria counts. Inlet and outlet pressure gauges are supplied to monitor the pressure drop across this filter. Inlet and outlet sample valves are furnished for sampling purposes.

Water Softener: Optional Spare Vessel

Filtered water may be passed through cation ion exchange resins preferably in the sodium form for hardness removal and to provide a “boundary layer” effect to assist in keeping colloidal particles in suspension. The softener may also be employed for iron removal and the reduction of alum or polyelectrolyte in the feed water.

1 Micron Reverse Osmosis Prefilter:

Carbon effluent water is passed through a cartridge filter, preferably a 1 micron nominally rated cartridge filter, in order to remove fine particles prior to the carbon filter. Inlet and outlet pressure gauges are supplied to monitor the pressure drop across this filter, which should be changed out when the pressure drop is 10-15 psig over and above the clean pressure drop for most effective operation and efficiency. The filter elements are made of polypropylene which is unable to support the growth of bacteria.

Reverse Osmosis System:

Treated water then flows into the Reverse Osmosis (RO) system where the majority of the ionized solids, organics, bacteria, colloidal materials, particles, and other contaminants remaining in the water are removed. A properly operating RO system will allow the remainder of the system components to operate very efficiently and economically.

The RO uses a semi-permeable membrane which allows water to pass through while rejecting 90 to 99% of nearly all contaminants present in the incoming water supply. The RO membrane is the finest filter in the entire water purification system with an average pore size of approx. 300 MWCO (molecular weight cutoff). The extremely fine pores of the RO system require the use of a high pressure pump in order to efficiently process water. RO systems are typically operated at pressures between 150 and 400 psi.

RO is a tangential flow process where the feed stream splits into treated water (called permeate or product water) and waste water (called reject or concentrate water) as it is processed. Contaminants present in the feed stream are removed from water that passes through the membrane and concentrate in the water that remains behind. It is important to maintain adequate flow in the “concentrate” stream to prevent contaminants from depositing on the membranes.

The RO system has a manually variable recovery rate (the amount of feed water that is converted into product water) which utilizes a needle valve. The system may also incorporate a concentrate recycling valve to recycle water back to the beginning of the RO system. The concentrate recycling valve is important since it minimizes water consumption while ensuring that there is adequate flow in the concentrate stream to prevent membrane fouling. The RO can be operated on warm or cold water supplies. As the water temperature is reduced, the amount of product water produced is also reduced due to increases in water viscosity and the shrinkage of pores associated with temperature changes.

The RO membranes may require periodic cleaning and should be cleaned if the product water flow-rate falls to 10% below normal (with temperature and pressure conditions the same).

The RO system is furnished with various instruments and controls to permit monitoring of its operation and performance.
Low pressure switch to protect the pump from low water pressure conditions.
Pressure gauges to permit monitoring of the membrane feed and concentrate pressures.
Flow meters for monitoring the product and reject stream flow rates.
Concentrate recycle valve and flow meter for water conservation.
Totalizing water meters to record the gallons of permeate and concentrate water produced by the system.
Conductivity monitor to measure the percent of ionized solids removed by the RO system (called percent rejection).
   Pressure Relief Valve:

The RO system employs a pressure relief valve to prevent the unintentional over-pressurization of the RO membranes which could damage the RO membranes.

Check Valve:

The RO system employs a check valve to prevent the unintentional over pressurization of the RO membranes which could damage the RO membranes.

DI Recirculation Pump:

When the unit is operating or in “stand-by mode”, a DI recirculation pump will continuously circulate water through the post treatment or high purity section of the system, (the UV, mixed bed DI and final filter). The pump's wettable surfaces are of materials compatible with the intended high purity water service the pump will see.

TOC Reducing UV Sterilization:

Water is passed through a TOC reducing ultraviolet sterilizer containing lamps which give off 185 nm wavelength radiation. The unit is designed to oxidize organics, converting them into weak acids and facilitating TOC control. The unit also produced conventional 254 nm wavelength radiation which is effective in bacteria control. The weak acids along with destroyed microorganisms will be removed by subsequent downstream treatment processes. Inlet and outlet sample valves are furnished for monitoring purposes.

The TOC reducing UV sterilizer is intended to operate only when water is being pumped through it. The operation of the unit is therefore interlocked with the operation of the DI recirculation pump and the RO pump.

Mixed Bed Deionization:

Water is pumped through mixed bed deionization comprised of mixed anion and cation ion exchange resins in order to provide essentially deionized or ultra high purity water. The high resistivity of the water in the system (>17.0 MegOhm) indicates the desired level of purity. This can be monitored by continuous resistivity readout present in the control panel.

The mixed bed tanks are portable, low TOC, type one mixed bed ion exchange type media which requires changing when the resistivity begins to fall below the normal operating quality for the system.

Final Filter:

Water is passed through a membrane filtration step using absolute rated membrane filters in order to remove any bacterial and fine particle contamination. Inlet and outlet pressure gauges are supplied to monitor the pressure drop across this filter, which should be changed out when the pressure drop is 10-15 psig for most effective operation and efficiency. A sampling valve is located after the filter housing to permit sampling of the water prior to distribution.

Resistivity Monitoring:

The quality of water being supplied to the Point of Use is monitored for resistivity.

Flowmeter:

Water flow is monitored with an inline flow meter which will indicate the flow rate through the system. The flow rate through the system is present by the RO and water temperature.

Pressure Control Valve:

A pressure control valve is installed after the RO to relieve pressure from the pump to drain.

Ozone Generator Node

The system will be equipped with an Ozone generation system to permit the unit to also provide SIP and CIP services.

WFI Node

The system will be equipped with a distillation module to facilitate the rapid production of WFI water as needed.

Control Panel Functional Description

The operation and sequencing of all components in the system are controlled by a programmable logic controller (PLC). The PLC contains relays, time delays, counters, etc. required for the smooth operation of the entire water system. The PLC contains a program, a copy of which is contained in the manual that details the exact content of the system operating logic and control sequences. The PLC contains a battery backup, which holds the contents of the program in memory for a period of up to 5 years in the event of a power outage.

The main control panel of the system provides the controls required for the system to operate automatically with a series of status lights, alarms, and manual switches to also permit the user to manually control the system. A simplified schematic of the system is mounted to the front of the control panel. This laminated schematic contains all the switches, pushbuttons, and status lights required for the operator to know and easily understand the exact operating condition of the system at all times.

The discussion below is intended to familiarize the user with the intended functions and controls associated with the operation of the control panel and the system as a whole. One main electrical power feed is required to operate the panel and the system as a whole.

The control panel functions will be discussed based on the lights and status indicators present and visible on the front cover of the panel.

Main Fuse Disconnect:

The main fuse disconnect switch controls the supply of power to the entire control panel and must be turned off in order to open up the panel cover to view the inner components.

Control Power Indicating Light:

The system main power light will indicate when the control system circuitry (120 VAC and 24 VDC) is activated. This circuit is protected by a fuse.

Reverse Osmosis System Controls:

The reverse osmosis system indicating light and associated pushbutton indicates the operating status of the reverse osmosis system. Depressing and releasing the push button once turns the unit on. Depressing and releasing the push button again turns the unit off. When the pushbutton for this is illuminated, the unit is in automatic and ready to go. When the pushbutton light is off (out), the unit will remain off. When the unit is on, the operation of the RO system is controlled by the PLC. When the RO system is operating, sufficient pressure must exist at the inlet to the high pressure RO pump or the unit will automatically shut off and go into a low pressure alarm. This alarm requires the operator to acknowledge the condition by depressing and releasing the alarm reset pushbutton. This alarm requires operator intervention to reset the unit and get it running again.

A motor starter is used to activate the RO system pump. A motor starter consists of a contactor and an overload. The contactor portion is a coil that is activated by a signal from the PLC. When the PLC pulls in the coil, power is sent to the pump. Prior to reaching the pump, power passes through the overload portion of the motor starter. The overload acts as a re-settable circuit breaker which continuously monitors the current draw of the pump when it is operating. As the pump wears and ages, or during low voltage conditions such as brown outs, the pump may begin to draw more current. The overload will trip out and stop the pump from operating if it is drawing more current than the overload setting. A signal is sent to the PLC indicating that either the pump is running or the overload has been tripped. When the overload is tripped, it must be reset manually by opening the control panel and pressing the reset button on the overload. A red alarm light indicating “pump tripped” is illuminated when a pump overload has tripped on excess current draw. When this occurs, the pump may require servicing.

DI Recirculation Pump Controls.

Depressing and releasing the push button once turns the DI pump on. Depressing and releasing the push button again turns the DI pump off. When the pushbutton for this is illuminated, the unit is in automatic and ready to go. When the pushbutton light is off (out), the unit will remain off.

A motor starter is used to activate the DI pump. A motor starter consists of a contactor and an overload. The contactor portion is a coil that is activated by a signal from the PLC. When the PLC pulls in the coil, power is sent to the pump. Prior to reaching the pump, power passes through the overload portion of the motor starter. The overload acts as a re-settable circuit breaker which continuously monitors the current draw of the pump when it is operating. As the pump wears and ages, or during low voltage conditions such as brown outs, the pump may begin to draw more current. The overload will trip out and stop the pump from operating if it is drawing more current than the overload setting. A signal is sent to the PLC indicating that either the pump is running or the overload has been tripped. When the overload is tripped, it must be reset manually by opening the control panel and pressing the reset button on the overload. A red alarm light indicating “pump tripped” is illuminated when a pump overload has tripped on excess current draw. When this occurs, the pump may require servicing.

TOC Reducing UV Unit Controls:

The TOC reducing UV unit running light and associated pushbutton switch will allow the operator to control the operating mode of the TOC reducing UV unit. Depressing and releasing the pushbutton once turns the unit on. Depressing and releasing the pushbutton again turns the unit off. When the pushbutton for this is illuminated, the unit is in automatic and ready to go. When the pushbutton light is off (out), the unit will remain off. When the TOC reducing UV unit is turned on, it will run only when the DI pump is operating or the RO pump is operating and water is flowing through the unit.

Resistivity Monitor:

The resistivity monitor is panel mounted and will indicate the specific resistance of the product water in recirculation and the product water supplied to the point of use.

Alarm Conditions:

The control panel is furnished with a number of protective devices and alarms to alert operators that the system requires servicing of some sort. Each alarm condition will light an appropriate specific alarm indicator light, the general alarm light, and close a set of dry “General Alarm” contacts for remote indication in the event that any of these alarm conditions occur.

In the event of an alarm occurrence, a red alarm light will remain illuminated until the alarm condition is corrected and the alarm reset button is depressed. The alarm conditions are:
Low feed water pressure to the RO system as determined by the pressure switch at the inlet side to the RO system.
Low resistivity at the point of use as monitored by the resistivity monitor.
Any of the system pumps have tripped out on excess current draw.
Low per cent rejection on the RO.

### DETAILED DESCRIPTION OF THE INVENTION

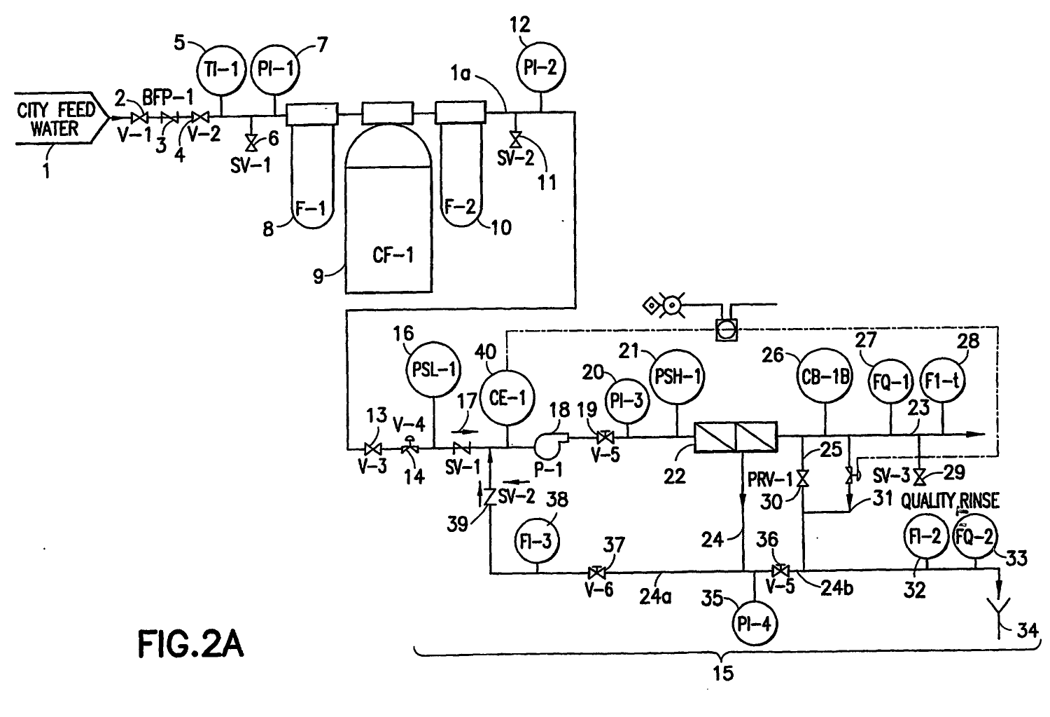

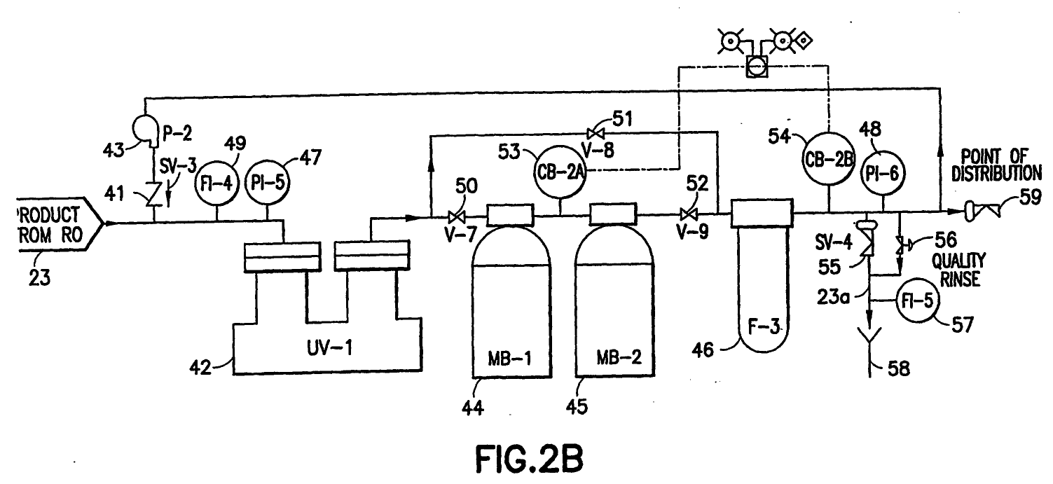

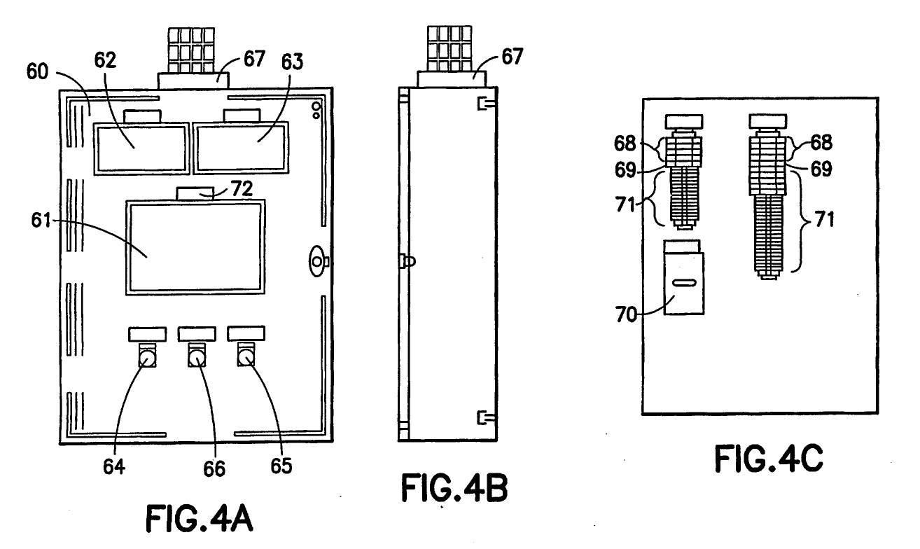

What follows is a detailed description of one embodiment of the present invention. The numbers refer primarily to FIGS. 2a, 2b, 4a, 4b and 4c.

Backflow Preventer:

Referring first to FIG. 2a, the source feed water (1) is connected to the ¾ inch inlet quick connect fitting (not shown). The fitting is followed by a first valve V-1 (2) and then a Backflow Preventer BFP-1 (3) which isolates city water from the process water which will be purified by this system, as required by local plumbing codes. Pressure PI-1 (7) and temperature TI-1 (5) gauges along with a second valve V-2 (4) and a first sample valve SV-1 (6) are installed after the Backflow Preventer BFP-1 (3).

5 Micron Prefilter:

The feed water is then passed through a 5 micron nominally rated cartridge filter (micron prefilter) F-1 (8) in order to remove fine particles prior to the carbon filter. The filter elements are made of polypropylene which does not support the growth of bacteria.

Carbon Filter:

After the filtered water is passed through the micron prefilter F-1 (8), it is passed through a carbon filter CF-1 (9) for the effective removal of small molecular weight organics and chlorine found in the incoming water supply. The granular carbon media should be changed every 3 months or every 50,000 gallons to prevent chlorine and/or organic breakthrough, or excess bacteria counts.

FIG. 2 shows a single carbon filter CF-1 (9). Optionally, the device can contain a plurality of carbon filters in serial communication with each other, such that the carbon filter effluent water from one carbon filter then passes through a next carbon filter, and so on.

1 Micron Reverse Osmosis Prefilter:

After the carbon filtration, the carbon filter effluent water is passed through a 1 micron nominally rated cartridge filter (reverse osmosis prefilter) F-2 (10) in order to remove fine particles prior to the Reverse Osmosis pump P-1 (18). A pressure gauge PI-2 (12) is supplied after the reverse osmosis prefilter F-2 (10). The filter elements of the reverse osmosis prefilter F-2 (10) should be changed out when the pressure drop on pressure gauge PI-2 (12) is 10-15 psig over and above the clean pressure drop for most effective operation and efficiency. The filter elements of the reverse osmosis prefilter F-2 (10) are made of polypropylene which is unable to support the growth of bacteria.

Also after the reverse osmosis prefilter F-10 (10) and the Reverse Osmosis pump P-1 (18) are a second sample valve SV-2 (11), the pressure gauge PI-2 (12), a third valve V-3 (13) and an actuated valve V-4 (14).

When there is a pressure drop of about 10-15 psig over and above the clean pressure as indicated by the first pressure valve PI-1 (7) and the second pressure valve PI-2 (12), the micron prefilter F-1 (8) should be changed.

Reverse Osmosis System (RO)

After the above, treated water (1a) flows into the Reverse Osmosis (RO) system (15) where the majority of the ionized solids, organics, bacteria, colloidal materials, particles, and other contaminants remaining in the water are removed. A properly operating RO system (15) will allow the remainder of the system components to operate very efficiently and economically.

The RO (15) uses a semi-permeable membrane (22) which allows water to pass through while rejecting from about 90 to about 99% of nearly all contaminants present in the incoming water supply. The RO membrane (22) is the finest filter in the entire water purification system. The RO (15) preferably removes 99% of the feed water particles, colloids, bacteria, endotoxins, and organics within a range of greater than 200-300 molecular weight. It also removes 90 to 99% dissolved inorganic compounds. The extremely fine pores of the RO system (15) require the use of a high pressure pump P-1 (18) in order to efficiently process waster. RO systems (15) are typically operated at pressures between about 150 and 400 psi.

RO (15) is a tangential flow process where the feed stream (1a) splits into treated water (called permeate or product water) (23) and waste water (called retentate, reject or concentrate) (24). Contaminants present in the feed stream (1a) are removed from water that passes through the membrane (22) and concentrate in the water that remains behind (24). It is important to maintain adequate flow in the “concentrate” steam (24) to prevent contaminants from depositing on the membranes (22). This is called concentration polarization.

The RO system (15) has a manually variable recovery rate (the amount of feed water that is converted into product water) which utilizes a needle valve (19). The system may also incorporate a concentrate recycling valve V-5 (36) to recycle water back to the beginning of the RO system (15). The concentrate recycling valve V-5 (36) is important since it minimizes water consumption while ensuring that there is adequate flow in the concentrate stream (24) to prevent membrane (22) fouling. The RO (15) can be operated on warm or cold water supplies. As the water temperature is reduced, the amount of product water produced is also reduced due to increases in water viscosity and the shrinkage of pores associated with temperature changes.

When concentrate recycling valve V-5 (36) is open and valve V-6 (37) is closed, waste water (24) is recirculated (24a) back to the beginning of the RO (15). The recirculated water (24a) passes by flow meter F1-3 (38) and through check valve CV-2 (39). The recirculated water (24a) is then reintroduced into the treated water (1a) after check valve CV-1 (17) and before Reverse Osmosis pump P-1 (18).

If valve V-5 (36) is open and valve V-6 (37) is closed, the waster water (24) is not recirculated. Rather, after passing pressure gauge PI-4 (35), the waste water (24) is released to the drain (34).

The RO membranes (22) may require periodic cleaning and should be cleaned if the product water flow-rate falls to 10% below normal (with temperature and pressure conditions the same).

The RO system (15) is furnished with various instruments and controls to permit monitoring of its operation and performance.
Low pressure switch PSL-1 (16) to protect the pump P-1 (18) from low water pressure conditions.
Pressure gauges PI-3 (20) and PI-4 (35) to permit monitoring of the membrane feed (1a) and concentrate (24a).
Flow meters FI-4 (28) and FI-2 (32) for monitoring the product (23) and reject (24b) stream flow rates.
Concentrate recycle valve V-5 (36) and flow meter FI-3 (38) for water conservation.
Totalizing water meters FQ-1 (27) and FQ-2 (33) to record the gallons of permeate and concentrate water produced by the system.
Conductivity monitor CE-1B (26) to measure the percent of ionized solids removed by the RO system (15) (called percent rejection).
   Pressure Relief Valve:

The RO system (15) employs a pressure relief valve PRV-1 (30) to prevent the unintentional back over pressurization of the RO membranes (22) which could damage the RO membranes (22). The valve (30) releases to drain (34).

Check Valves:

The RO system (15) employs check valves CV-1 (17), CV-2 (30) and CV-3 (41) to prevent the unintentional over pressurization of the RO membranes (22) which could damage the RO membranes (22).

TOC Reducing UV Sterilizer:

Referring now to FIG. 2b, water (23), preferably in teflon tubing, is passed through a TOC reducing ultraviolet sterilizer UV-1 (42) containing lamps which give off 185 nm wavelength radiation. The unit is designed to oxidize organics, converting them into weak acids and facilitating TOC control. The unit also produces conventional 254 nm wavelength radiation which is effective in bacteria control. The weak acids along with destroyed microorganisms are removed by subsequent downstream treatment processes. Inlet and outlet sample valves (not shown) are furnished for monitoring purposes.

The TOC reducing UV sterilizer UV-1 (42) is intended to operate only when water (23) is being pumped through it. The operation of the unit is therefore interlocked with the operation of the DI recirculation pump P-2 (43) and RO pump P-1 (18). Also, before the water (23) reaches UV sterilizer UV-1 (42), it is measured by flow meter FI-4 (49) and pressure gauge PI-5 (48).

Mixed Bed Deionization:

After treatment in UV-1 (42), the water is pumped through mixed bed deionization MB-1 (44) and MB-2 (45) comprised of mixed anion and cation ion exchange resins in order to provide essentially deionized or ultra high purity water. The high resistivity of the water in the system (>17.0 MegOhm) indicates the desired level of purity. This can be monitored by continuous resistivity readout CE-2A (53) present in the control panel (60).

Provision is made for bypassing tanks MB-1 (44) and MB-2 (45). This bypass is used, for example, when the water system is chemically sanitized. In this event, valve V-7 (50), placed before tank MB-1 (44) and valve V-9 (52) placed after tank MB-2 (45) would close, and valve V-8 (51) would open, thus allowing the bypass.

The mixed bed tanks MB-1 (44) and MB-2 (45) are portable, low TOC type one mixed bed ion exchange type media which requires changing when the resistivity begins to fall below the normal operating quality for the system.

Final Filter:

Water is passed through a final filter F3 (46) membrane filtration step using absolute rated membrane filters in order to remove any bacterial and fine particle contamination. Preferably, this filter is a 0.2 or 0.1 micron filter. Pressure gauges PI-5 (47) and PI-6 (48) monitor the pressure drop across this filter as well as the previous Mixed Beds (44 and 45). The cartridges should be changed out when the pressure drop is 1-15 psig for most effective operation and efficiency. A sampling valve SV-4 (55) is located after the filter housing to permit sampling of the water prior to distribution.

Resistivity Monitoring:

The quality of water being supplied to the Point of Use (59) is monitored by a conductivity gauge CE-2B (54) for resistivity. The water is diverted (23a) via Quality Rinse (56) to drain (58) if the resistivity is below 17 MegOhms. There is also provided a sample value SV-4 (55) for sampling the water. The water (23a) which passes to the drain (58) is measured by flow meter FI-5 (57). If resistivity is at or above 17 MegOhms, and preferably 18 MegOhms or higher, the water is delivered to the Point of Distribution (59).

DI Recirculation Pump:

When the unit is operating or in “stand-by mode”, a DI recirculation pump P-2 (43) will continuously circulate water through the post treatment or high purity section of the system, (the UV (42), mixed bed DI (44 and 45) and final filter (46)). The pump's (43) wettable surfaces are of materials compatible with the intended high purity water service. This recirculation is useful for microbial control.

Water Softener (Optional Spare Vessel):

Filtered water may be passed through a cation ion exchange resins in the Sodium form for hardness removal and to provide a “boundary layer” effect to assist in keeping colloidal particles in suspension. The softener may also be employed for iron removal and the reduction of alum or polyelectrolyte in the feed water.

Ozone Generator Node:

The system may be equipped with an Ozone generation system to permit the unit to also provide Steam in Place (SIP) and Clean in Place (CIP) services.

Control Panel:

The control panel (60) is shown in FIGS. 4a-4c.
Main Fuse Disconnect:

The main fuse disconnect switch (72) controls the supply of power to the entire control panel and must be turned off in order to open up the panel cover to view the inner components.
Control power Indicating Light:

The system main power light (61) will indicate when the control system circuitry (120 VAC and 24 VDC) is activated. This circuit is protected by a fuse.
Programmable Logic Controller (PLC)

The operation and sequencing of all components in the system are controlled by a programmable logic controller (PLC). The PLC contains relay functions, time delays, counters, etc. required for the smooth operation of the entire water system. The PLC operates with a program that details the exact content of the system operating logic and control sequences. The PLC has a battery backup, which holds the contents of the program in memory for a period of up to 5 years.

The main control panel (60) of the system provides the controls required for the system to operate automatically with a series of status lights, alarms, and manual switches to also permit the user to manually control the system. A simplified schematic of the system is mounted to the front of the control panel. This laminated schematic contains all the switches, pushbuttons, and status lights required for the operator to know and easily understand the exact operating condition of the system at all times. One main electrical power feed (70) is required to operate the panel and the system as a whole.

Reverse Osmosis Systems Controls:

The reverse osmosis system indicating light (61) and associated pushbutton (64) indicates the operational status of the reverse osmosis system (15). Depressing and releasing the push button (64) once turns the unit on. Depressing and releasing the pushbutton (64) against turns the unit off. When the pushbutton (64) for this is illuminated, the unit is in automatic and ready to go. When the pushbutton (64) light is off (out), the unit will remain off. When the unit is on, the operation of the RO system (15) is controlled by the PLC. When the RO system (15) is operating, sufficient pressure must exist at the inlet to the high pressure RO pump P-1 (18) or the unit will automatically shut off and go into a low pressure alarm (61). This alarm (61) requires the operator to acknowledge the condition by depressing and releasing the alarm reset pushbutton (61). This alarm (61) requires operator intervention to reset the unit and get it running again.

A motor starter is used to activate the RO system pump P-1 (18). A motor starter consists of a contactor and an overload. The contactor portion is a coil that is activated by a signal from the PLC. When the PLC pulls in the coil, power is sent to the pump P-1 (18). Prior to reaching the pump P-1 (18), power passes through the overload portion of the motor starter. The overload acts as a re-settable circuit breaker which continuously monitors the current draw of the pump P-1 (18) when it is operating. As the pump P-1 (18) wears and ages, or during low voltage conditions such as brown outs, the pump P-1 (18) may begin to draw more current. The overload will trip out and stop the pump P-1 (18) from operating if it is drawing more current than the overload setting. A signal is sent to the PLC indicating that either the pump P-1 (18) is running or the overload has been tripped. When the overload is tripped, it must be reset manually by opening the control panel and pressing the reset button on the overload. A red alarm light indicating “pump tripped” is illuminated when a pump overload has tripped on excess current draw. When this occurs, the pump P-1 (18) may require servicing.

DI Recirculation Pump Controls:

Depressing and releasing the pushbutton (66) once turns the DI pump P-2 (43) on. Depressing and releasing the pushbutton (66) again turns the DI pump P-2 (43) off. When the pushbutton (66) for this is illuminated, the unit is in automatic and ready to go. When the pushbutton (66) light is off (out), the unit will remain off.

A motor starter is used to activate the DI pump P-2 (43). A motor starter consists of a contactor and an overload. The contactor portion is a coil that is activated by a signal from the PLC. When the PLC pulls in the coil, power is sent to the pump P-2 (43). Prior to reaching the pump P-2 (43), power passes through the overload portion of the motor starter. The overload acts as a re-settable circuit breaker which continuously monitors the current draw of the pump P-2 (43) when it is operating. As the pump P-2 (43) wears and ages, or during low voltage conditions such as brown outs, the pump P-2 (43) may begin to draw more current. The overload will trip out and stop the pump P-2 (43) from operating if it is drawing more current than the overload setting. A signal is sent to the PLC indicating that either the pump P-2 (43) is running or the overload has been tripped. When the overload is tripped, it must be reset manually by opening the control panel and pressing the reset button on the overload. A red alarm light indicating “pump tripped” is illuminated when a pump overload has tripped on excess current draw. When this occurs, the pump P-2 (43) may require servicing.

TOC Reducing UV Unit Controls:

The TOC reducing UV unit running light and associated pushbutton switch (65) will allow the operator to control the operating mode of the TOC reducing UV unit UV-1 (42). Depressing and releasing the pushbutton (65) once turns the unit UV-1 (42) on. Depressing and releasing the pushbutton (65) again turns the unit UV-1 (42) off. When the pushbutton (65) for this is illuminated, the unit UV-1 (42) is in automatic and ready to go. When the pushbutton (65) light is off (out), the unit UV-1 (42) will remain off. When the TOC reducing UV unit UV-1 (42) is turned on, it will run only when the DI pump P-2 (43) is operating or the RO pump P-1 (18) is operating and water is flowing through the unit.

Resistivity Monitor:

The resistivity monitors (62, 63) are panel mounted and will indicate the specific resistance of the RO product water (62) and the product water in recirculation and the product water supplied to the point of use (63).

Alarm Conditions:

The control panel is furnished with a number of protective devices and alarms to alert operators that the system requires servicing of some sort. Each alarm condition will light an appropriate specific alarm indicator light, the general alarm light (67), and close a set of dry “General Alarm” contacts for remote indication in the event that any of these alarm conditions occur.

In the event of an alarm occurrence, a red alarm light will remain illuminated until the alarm condition is corrected and the alarm reset button is depressed. The alarm conditions are:
Low feed water pressure to the RO system (15) as determined by the pressure switch PSL-1 (16) at the inlet side to the RO system (15).
Low resistivity at the point of use as monitored by the resistivity monitor.
Any of the system pumps P1 (18) or P-2 (43) have tripped out on excess current draw.
Low per cent rejection on the RO (15).

What is claimed is:

1. A water purification system which comprises:
a. an intake for receiving water;
b. a first cartridge filter operatively connected to said intake for receiving water from said intake;
c. A carbon filter operatively connected to said first cartridge filter for receiving water from said first cartridge filter;
d. a second cartridge filter operatively connected to said carbon filter for receiving water from said carbon filter;
e. a reverse osmosis system operatively connected to said second cartridge filter for receiving water from said second cartridge filter, said reverse osmosis system comprising a reverse osmosis filter;
f. an ultraviolet sterilizer operatively connected to said reverse osmosis system for receiving water from said reverse osmosis system;
g. a mixed bed deionizer operatively connected to said ultraviolet sterilizer for receiving water from said ultraviolet sterilizer;
h. a third cartridge filter operatively connected to said mixed bed deionizer for receiving water from said mixed bed deionizer; and
i. a discharge operatively connected to said third cartridge filter for receiving water from said third cartridge filter, wherein said discharge discharges purified water.

2. The water purification system of claim 1 wherein said first cartridge filter is a 5 micron filter.

3. The water purification system of claim 1 wherein said carbon filter contains granular carbon.

4. The water purification system of claim 1 further comprising one or a plurality of additional carbon filters operatively connected to said carbon filter for receiving water from said carbon filter.

5. The water purification system of claim 1 wherein said second cartridge filter is a 1 micron filter.

6. The water purification system of claim 1 wherein said reverse osmosis filter removes from about 90% to about 99% contaminants within a range of greater than 200 to 300 molecular weight.

7. The water purification system of claim 1 wherein said reverse osmosis system further comprises a high pressure pump which operates the reverse osmosis system at pressures between about 150 and 400 psi.

8. The water purification system of claim 7 wherein said reverse osmosis system further comprises a pressure relief valve to prevent over pressurization of the reverse osmosis filter.

9. The water purification system of claim 1 wherein the ultraviolet sterilizer produces 185 run wavelength radiation.

10. The water purification system of claim 9, wherein the ultraviolet sterilizer also produces 254 nm wavelength radiation.

11. The water purification system of claim 1 wherein the mixed bed deionizer comprises mixed anion and cation exchange resins.

12. The water purification system of claim 1 wherein the mixed bed deionizer comprises two tanks.

13. The water purification system of claim 1 wherein the third cartridge filter comprises absolute rated membrane filters.

14. The water purification system of claim 1 which further comprises a conductivity gauge situated after the third cartridge filter for measuring resistivity of the water, such that if the resistivity of the water is below 17 MegOhms, the water is diverted to a drain.

15. The water purification system of claim 1 further comprising a bypass of the mixed bed deionizer, said mixed bed deionizer being by passed when the water is chemically treated.

16. The water purification system of claim 1, wherein the reverse osmosis system further comprises a tangential flow wherein the water is split into treated water, which is water that has had its contaminants removed by the reverse osmosis filter, and waste water, which is the water remaining behind.

17. The water purification system of claim 16, wherein the waste water is either diverted to a drain or is recycled into the reverse osmosis system.
